(19) United States
(12) Patent Application Publication
(10) Pub. No.: US 2001/0025213 A1
(43) Pub. Date: Sep. 27, 2001

(54) Fall-protected autonomous travel system with boundary markers

(75) Inventor: Hermann-Josef Wiegand, Rasdorf (DE)

Correspondence Address: BAKER & BOTTS, 30 ROCKEFELLER PLAZA, NEW YORK, NY, 10112

(73) Assignee: SIEMENS AG.

(21) Appl. No.: 09/840,510

(22) Filed: Apr. 23, 2001

Related U.S. Application Data
(63) Continuation of application No. PCT/DE99/03264, filed on Oct. 11, 1999.

(30) Foreign Application Priority Data
Oct. 23, 1998 (DE) 29818922.4

(51) Int. Cl. G01C 21/00

(52) U.S. Cl. 701/23; 701/200

(57) ABSTRACT

A fall-protected autonomous travel system with boundary markers is disclosed. The boundary markers are arranged in a travel area of a mobile unit. The mobile unit contains a spatial scanning device with a sensing range in which the travel area of the mobile unit is scanned in the mobile unit's direction of travel. A program-controlled control device brings the mobile unit to a stop if the spatial scanning device senses at least one boundary marker in a first safety sub-range of the sensing range.

### FIELD OF THE INVENTION

The present invention relates generally to an autonomous travel system which contains self-propelling mobile units. In particular, the invention relates to the protection of the self-propelled mobile units.

### BACKGROUND OF THE INVENTION

An autonomous travel system can be used, for example, in the form of a driver-less transport system for a wide variety of tasks. An example of such a task is the transportation of a cleaning device. Such travel systems are also referred to as autonomous cleaning robots.

Prior travel systems have contactless guides which are placed into the floor of the respective travel area, for example in an industrial building. These contactless guides are used as a type of electronic rail or track, for example on a magnetic basis, for self-propelling the mobile units of the travel system.

In other prior travel systems, the self-propelling mobile units, which may also be referred to as mobile robots, move in an assigned travel area in a quasi-autonomous fashion under the control of a control device which is generally program-controlled. The control device scans a sensing range located at least in the direction of travel in front of a mobile unit using a contactless spatial scanning device. This may be a pulse laser scanner or an ultrasonic sensor system. The control device executes a navigation program which, for example in the case of an autonomous cleaning robot, has the function of moving the mobile unit with the most uniform possible coverage over the entire travel area so that the cleaning device which it carries can carry out the cleaning task.

In addition to the navigation program, the program-controlled control device generally also carries out a collision program which prevents a collision between a mobile unit and objects which are detected in the sensing range. In the case of moveable objects, for example persons, in order to avoid collisions the collision program can temporarily bring the mobile unit to a stop until the movable object has left the sensing range. In the case of fixed objects, such as articles and parts of buildings, detours are made under certain circumstances.

A further safety function which may also possibly be required by public supervisory authorities for autonomous travel is that the autonomous travel system be protected under all circumstances against falling. The risk of falling occurs generally if, for example, due to an error or an irregularity in the execution of the normal navigation program a mobile unit arrives at a position which is unforeseen.

In order to protect against falling, the travel system can have additional structural measures for physically delimiting the assigned travel area, for example grills and barriers. However, such mechanical boundaries are not only costly but, for practical reasons, in many cases cannot be installed at areas where falling is possible, for example staircases, ramps, railroad platforms.

As an attempt to solve this problem, EP-A-0 774 702 discloses a system which is used by an automated robot to detect the limits of its operating range. The limits are provided with magnetic markers which can be detected by a magnet sensor mounted on the robot.

As another attempt to solve the above falling problem, U.S. Pat. No. 5,165,064 describes a mobile robot which scans the surroundings with ultrasonic and infrared signals and can determine its position by means of infrared beacons installed in the surroundings.

There exists an need for a more efficient and less costly autonomous travel system which protects the mobile units of the autonomous travel system against falling.

### SUMMARY OF THE INVENTION

The present invention provides a system and method for protecting the mobile units of an autonomous travel system against falling. The fall-protected autonomous travel system of the present invention has at least one mobile unit equipped with at least one control device and a contactless spatial scanning device in such a way that it is possible to protect the mobile unit against falling with a minimum possible additional expenditure.

The fall-protected autonomous travel system according to the present invention contains boundary markers which are arranged spatially distributed in the travel area. In addition, at least one self-propelling mobile unit of the travel system contains a contactless spatial scanning device with a sensing range in which the spatial scanning device scans at least the travel area located in front of the mobile unit in the mobile unit's direction of travel. Furthermore, the self-propelling mobile unit of the travel system contains a program-controlled control device which is connected to the spatial scanning device and brings the mobile unit to a stop if the spatial scanning device senses at least one boundary marker in a first safety sub-range of the sensing range.

The system according to the present invention is based on a minimum safety criterion to protect the mobile unit against falling. The minimum safety criterion requires it to be impossible for a boundary marker to be located within the first safety sub-range of the sensing range or to be detected by the control device. If this condition is fulfilled, the mobile unit can be moved unimpeded by the control device in accordance with the navigation strategy depending, in particular, on the type of mobile unit. The system according to the present invention can consequently be compared for illustrative purposes with a virtual optical barrier which does not become active until the mobile unit has reached virtual limits determined by boundary markers. The protection against falling according to the present invention thus can be used without restriction in an additive fashion along with further navigation and safety programs which are generally already provided and act on the control device.

Such an embodiment has the further advantage that, in order to achieve the additional function of protecting against falling in existing self-propelling mobile units, it is not necessary to undertake any external structural changes. Instead, the function of the protection against falling can be implemented by the control device adapting the system and method of the present invention. These adaptations may be carried out by loading program components.

It is also particularly advantageous that the protection against falling is achieved by defining an additional, appropriately configured safety sub-range in the sensing range of the spatial scanning device which is generally provided in any case for purposes of normal navigation and/or avoidance of collisions and is appropriately evaluated by the program-controlled control device. The program of the control device evaluates this specific segment of the sensing range separately with the aim of protecting the mobile unit against falling.

A further advantage of the present invention is that the boundary markers, which are spatially distributed in the travel area, do not constitute any artificial obstacles, in particular for persons. Instead, they can be mounted, for example, on parts of buildings such as walls, columns, ceilings and the like without adversely affecting existing spatial structures and movement structures. Due to the length of the sensing range and of the safety sub-range located in it, the boundary markers do not need to be mounted in the direct spatial vicinity of a location where the mobile units could fall. Instead, they can be placed at a distance equal to up to a maximum length of the safety sub-range, i.e. the maximum length of the virtual optical barrier of the system. For example, if the location at which falling is possible is a landing on a flight of stairs, its accessibility for persons is not adversely affected by boundary markers of the travel system according with the present invention.

### BRIEF DESCRIPTION OF THE DRAWINGS

For a complete understanding of the present invention and the advantages thereof, reference is now made to the following description taken in conjunction with the accompanying drawings in which like reference numbers indicate like features, components and method steps, and wherein:

FIG. 1 is an illustration of a plan view of a mobile unit which is guided in a fall-protected fashion on a travel area in accordance with the present invention.

### DETAILED DESCRIPTION OF THE INVENTION

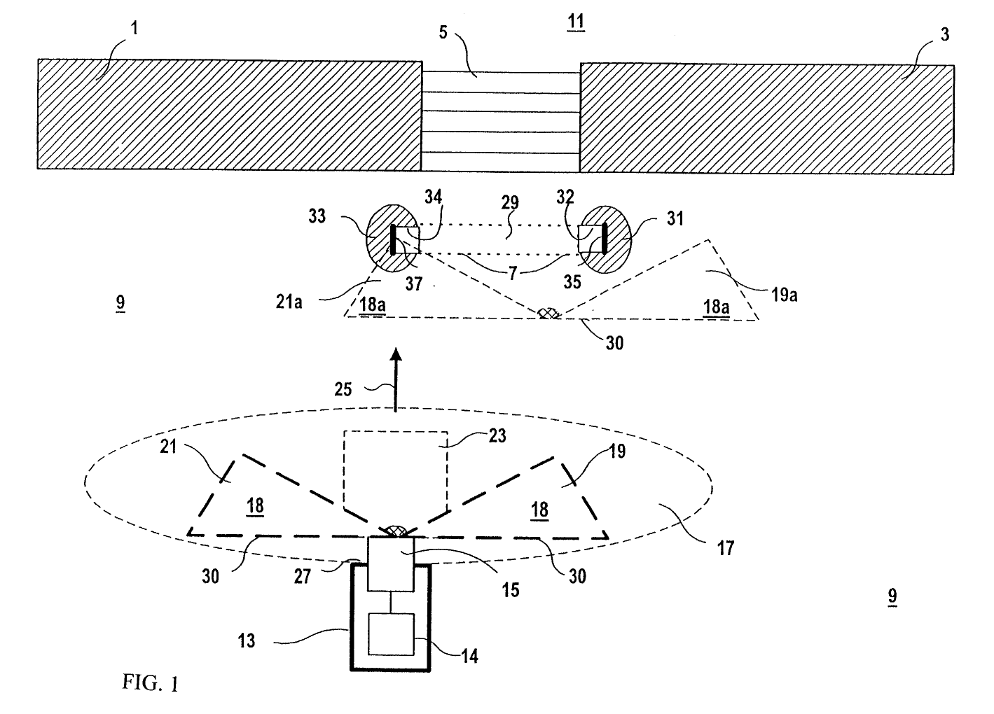

Now referring to the drawing, FIG. 1 illustrates a plan view of a mobile unit which is guided in a fall-protected fashion on a travel area in accordance with the present invention, the travel area having, by way of example, a step area 5 as an area where falling is possible. FIG. 1 shows a plan view of a travel area 9 which can be located, for example, in the interior of a building or a hall. Area 9 is bounded structurally by individual wall areas 1, 3, for example. In the exemplary embodiment of FIG. 1, this travel area 9 forms a raised travel level for an exemplary self-propelling mobile unit 13. Area 9 is separated from a further lower planar area 11 by means of a step-like area 5. The autonomous travel system according to the present invention ensures that the self-propelling mobile unit 13 does not, under any circumstances, travel over the step area 5 which constitutes an area where falling is possible.

In the exemplary embodiment of FIG. 1, the two boundary markers 35, 37 are arranged spatially distributed in the vicinity of area 5, where there is a risk of falling. Of course, further boundary markers, which are not shown in FIG. 1 and which are spatially distributed in order to protect further areas where falling is possible, may also be provided. In FIG. 1, the boundary markers 35, 37 are advantageously arranged approximately opposite and in front of the step area 5 which constitutes a tunnel-shaped area where falling is possible. The boundary markers 35, 37, which are arranged approximately on each side near to the access to area 5, form a type of no-go area 29 for the mobile unit, which area corresponds approximately to the access area for persons.

The self-propelling mobile unit 13, in this exemplary embodiment, is located in a position which is not at risk and is relatively far from the boundary markers 35, 37 and contains a contactless spatial scanning device 15 with a sensing range 17. The spatial scanning device 15, preferably a pulse laser scanner, is mounted at the head end 27 of the mobile unit 13 and is connected via a data bus to a control device 14. The sensing range 17 has an oval cross section as illustrated in FIG. 1. The portion of the travel area 9, which is located at least in front of the mobile unit 13 in the direction 25 of travel in the sensing range 17, is scanned by the spatial scanning device 15. In the position of the mobile unit 13 shown in the exemplary embodiment of FIG. 1, there is no boundary marker in the sensing range 17. The mobile unit 13 can therefore be moved on the travel area by processing a navigation program in the control device 14 in accordance with the function of the mobile unit 13.

In accordance with the present invention, only a part of the sensing range 17 is evaluated by the program-controlled control device 14 in the mobile unit 13 for the purpose of protecting against falling. Such part of the sensing range is referred to below as a first safety sub-range 18. The first safety sub-range 18 advantageously has in each case right-hand and left-hand sensing lobes 19 and 21, respectively, which are approximately directed away from the direction 25 of travel of the mobile unit 13 on each side of mobile unit 13. The maximum extent of the two sensing lobes transversely with respect to the direction of travel is indicated with the reference number 30.

In accordance with the present invention, the mobile unit 13 is brought to a stop by the control device if, due to its movements, a boundary marker 35, 37 enters the first safety sub-range 18 of the sensing range 17 and is sensed by the spatial scanning device 15. Preferably, at least one of the boundary markers 35, 37 is sensed, the mobile unit 13 is brought to a forced stop so that the mobile unit 13 cannot be reactivated without intervention by an operator.

In the example in FIG. 1, in order to illustrate this case, a safety sub-range 18a is additionally illustrated by a broken line without the associated mobile unit 13 in a second position which lies directly in front of the no-go area 29 defined by the boundary markers 35, 37. Here, the boundary marker 37 is, by way of example, located in the left-hand sensing lobe 21a of a safety sub-range 18a and is thus detected by the spatial scanning device 15 and the control device 14. This results in the mobile unit 13 being brought to a stop in order to prevent a fall.

The maximum extent 30 of the first safety sub-range 18a, in particular transversely with respect to the direction 25 of travel of the mobile unit 13, determines, the width of the “optical barrier” of the travel system according to the present invention within the framework of the protection against falling. The distance 7 between adjacent boundary markers 35, 37 is advantageously smaller than the maximum extent 30 of the first safety sub-range 18 transversely with respect to the direction 25 of travel. As can be seen particularly clearly from the position, shown by broken lines of the sensing range 18a which is moved forward, such dimensions of the safety sub-range 18 rule out the possibility of a mobile unit entering, for example as a result of incorrect navigation, the no-go area 29, and thus arriving in a position where there is a risk of falling. In addition, the extents, in particular of the right-hand sensing lobes 19, 19a and left-hand sensing lobes and 21, 21a of the first safety sub-range 18 and 18a in the direction 25 of travel determine the advancing of the area in which the mobile unit is brought to a stop when there is a risk of falling, and are to be matched in particular to the current speed of the mobile unit.

According to a further embodiment, the fall-protected autonomous travel system advantageously has carriers for holding guide markers which are configured and/or mounted in such a way that a boundary marker 35, 37 can be detected by the sensing range 17 of a mobile unit 13 only if the latter is located in the direct spatial vicinity of the boundary marker 35, 37. Such carriers are preferably column-shaped or can be hemispherical and are mounted on ceilings or supporting parts of buildings, or placed into the floor of the travel area. As illustrated in FIG. 1, the carriers 31, 33 advantageously have additional screening means for the boundary markers 35, 37, in particular, in the form of troughs 32, 34 and lateral covers. The troughs 32, 34 have the effect of preventing the boundary markers 35, 37 from being detected by the spatial scanning device 15 of a mobile unit 13 which is at a spatially remote location. In this case, the detection of boundary markers 35, 37 it is necessary for the mobile unit 13 to be in the direct spatial vicinity to such an extent that the safety sub-range of the mobile unit 13 is irradiated behind the screening means. The safety sub-range 18a shown by broken lines in FIG. 1 shows such a case using the example of the left-hand sensing lobe 21a.

The boundary markers 35, 37 themselves can be, for example, in the form of a foil which is placed on the outside of a carrier or in the container of a screening means. In addition, the surfaces of boundary markers 35, 37 may be shaped in such a way that they can be detected by the spatial scanning device 15, for example a pulse laser scanner, and the control device of a mobile unit, not only as markers in general but also specifically as boundary markers which serve to protect against falling. As a result, these markers can be automatically distinguished by the travel system from other markers which are arranged in the travel area for some other purpose which does not serve to protect against falling.

As already stated, other segments may be defined in the sensing range 17 of the spatial scanning device 15 and evaluated by the control device 14 for other purposes, for example for the avoidance of collisions. In the example in FIG. 1, the sensing range 17 contains a second safety sub-range 23 approximately directly in the direction 25 of travel of the mobile unit 13. The mobile unit 13 is temporarily brought to a forced stop here by the control device 14 if the spatial scanning device 15 senses a body located in the second safety sub-range 23. After the body is removed, the mobile unit 13 can advantageously begin to move again independently.

The present system and method provide for protecting the mobile units of the autonomous travel system against falling. The fall-protected autonomous travel system protects the mobile unit against falling with a minimum possible additional expenditure.

Although the present invention has been described in detail with reference to specific exemplary embodiments thereof, various modifications, alterations and adaptations may be made by those skilled in the art without departing from the spirit and scope of the invention. It is intended that the invention be limited only by the appended claims.

1. A fall-protected autonomous transport system, said autonomous transport system comprising:
at least two boundary markers which are arranged spatially distributed in a travel area;
at least one self-propelling mobile unit comprising:
a contactless spatial scanning device with a sensing range in which said spatial scanning device scans at least said travel area located in front of said mobile unit in a direction of travel of said mobile unit; and
a program-controlled control device which is connected to said spatial scanning device and controls said mobile unit by means of navigation and safety programs, wherein a first safety sub-range is within said sensing range, and, if said spatial scanning device senses at least one of said boundary markers in said first safety sub-range, said control device bringing said mobile unit to a stop to protect said mobile unit against falling, said navigation and safety programs being used additively to act on said control device.

2. The fall-protected autonomous transport system as claimed in claim 1, wherein said first safety sub-range has a right-hand sensing lobe and a left-hand sensing lobe, said sensing lobes being approximately directed away from said direction of travel of said mobile unit on each side of said mobile unit.

3. The fall-protected autonomous transport system as claimed in claim 1, wherein the distance between adjacent boundary markers is less than a maximum length of said first safety sub-range.

4. The fall-protected autonomous transport system as claimed in claim 1 further comprising carriers for holding said boundary markers, said carriers being which are configured in such a way that said boundary markers can be sensed only by said mobile unit within said sensing range.

5. The fall-protected autonomous transport system as claimed in claim 4, wherein said carriers have screening means for said boundary markers against spatially remote sensing by said spatial scanning device of a mobile unit.

6. The fall-protected autonomous transport system as claimed in claim 5, wherein said screening means comprises troughs.

7. The fall-protected autonomous transport system as claimed in claim 5, wherein said screening means comprises lateral covers.

8. The fall-protected autonomous transport system as claimed in claim 1, wherein at least two boundary markers are arranged such that one of said at least two boundary markers is opposite of said other of said at least two boundary markers in a travel area in front of a fall area.

9. The fall-protected autonomous transport system as claimed in claim 1, wherein said sensing range has a second safety sub-range, said second safety sub-range being approximately directly in said direction of travel of said mobile unit, and said control device temporarily bringing said mobile unit to a forced stop if said spatial scanning device senses a body located in the second safety sub-range.
